(19) United States
(12) Patent Application Publication
(10) Pub. No.: US 2023/0170624 A1
(43) Pub. Date: Jun. 1, 2023

(54) MECHANICAL META-MATERIAL BASED ELECTROMAGNETIC WAVE ABSORBER

(71) Applicant: AGENCY FOR DEFENSE DEVELOPMENT, Daejeon (KR)

(72) Inventors: Jin-Woo PARK, Daejeon (KR); Jung-Kun SONG, Daejeon (KR); Eun-Kyung JUN, Daejeon (KR); Ki-Soo LEE, Daejeon (KR); Jae-Ho CHOI, Daejeon (KR); Da-Hyun LIM, Daejeon (KR); Won-Jun CHOI, Daejeon (KR)

(21) Appl. No.: 17/827,983

(22) Filed: May 30, 2022

(30) Foreign Application Priority Data
Nov. 30, 2021 (KR) 10-2021-0169398

(51) Int. Cl. H01Q 17/00

(52) U.S. Cl. CPC H01Q 17/008

(57) ABSTRACT

The present invention relates to a mechanical meta-material based electromagnetic wave absorber, wherein a shape of the electromagnetic wave absorber is any one of a kelvin-foam, an octet-truss, a body-centered cubic lattice, a simple cubic triply minimal surface (SC-TPMS), and a cubic cellular core (CCC) and a honeycomb, a dielectric loss of the electromagnetic wave absorber is controlled by changing a strut diameter of a unit cell including at least one of carbon black, carbon nanotube, carbon fiber and graphene constituting the electromagnetic wave absorber.

### CROSS-REFERENCE TO RELATED APPLICATION

The present application claims priority to Korean Patent Application No. 10-2021-0169398, filed on Nov. 30, 2021, the entire contents of which is incorporated herein for all purposes by this reference.

### BACKGROUND OF THE INVENTION

### Field of the Invention

The present invention relates to an electromagnetic wave absorber, and more particularly, to a lightweight and high rigid structure using a mechanical meta-material.

### Description of the Related Art

In an electromagnetic (EM) wave absorber design, which is the background of the present invention and can absorb a broadband electromagnetic wave by using the electromagnetic properties of a metal-coated dielectric fiber, an electromagnetic wave absorber with a honeycomb sandwich structure including at least two or more honeycomb core layers in which hexagonal units are continuously arranged with a material including a metal-coated dielectric fiber, and a boundary layer including a bottom layer, an uppermost layer and an intermediate layer disposed on the top and bottom surfaces of the at least two or more honeycomb core layers has been studied. In addition, as a broadband electromagnetic wave absorber, it includes a magnetic composite having a structure in which magnetic particles are dispersed in a polymer resin and a plurality of conductive lines arranged in the magnetic composite, and its properties, which can be used in devices that emit electromagnetic waves to effectively absorb broadband electromagnetic waves, have also been known. Also, a lightweight sandwich plate having a foam core reinforced with a periodic porous material in the form of a truss, configured to include a three-dimensional truss-shaped porous material having a plurality of cells formed therein, a foam core filled in the cells, and an upper and lower materials disposed on the upper and lower sides of the porous material having a three-dimensional truss shape and resin-bonded to the foam core, is also known.

Further, through the complementary reaction of the foam-filled foam core material and the porous material having a three-dimensional truss shape, effects such as strength improvement of intermediate material, buckling suppression, heat insulation performance and sound insulation improvement, vibration absorption capacity improvement, etc. can be obtained. Still further, by using simple and established technology, production costs can be reduced and mass production can be easily obtained. A method of improving the strength of intermediate materials and manufacturing lightweight structures through truss structures, or a method of fabricating a broadband electromagnetic wave absorber through a polymer in which particles are dispersed has already been known. Recently, development of an electromagnetic wave absorber using a material having a dielectric loss property is on the rise.

### SUMMARY OF THE INVENTION

The technical object of the present invention is to provide an absorber that can be used as a broadband electromagnetic wave absorption and lightweight and high rigidity material by utilizing a three-dimensional mechanical meta-material and a dielectric loss material.

In addition, the present invention is to provide a method for manufacturing a broadband, lightweight and high rigidity material with an additive manufacturing process.

The present invention relates to an electromagnetic wave absorber that can control the electromagnetic wave absorption capacity by changing any one or more of the length, diameter, and relative density of a unit cell of a mechanical meta-material by using a dielectric loss material applicable to an additive manufacturing process.

In the present invention, the dielectric loss material used in the additive manufacturing process may include at least one of carbon black, carbon nanotube, carbon fiber, graphene, and a conductive polymer.

In the present invention, the unit cell of the electromagnetic wave absorber may include at least one of a kelvin-foam, an octet-truss, a body-centered cubic lattice, a simple cubic triply minimal surface (SC-TPMS), and a cubic cellular core (CCC) and a honeycomb.

In the present invention, the unit cell of the electromagnetic wave absorber may include a multilayer composite structure manufactured by combining unit cells having different diameters.

In the present invention, the composite structure may include a combination of a plurality of structures having the same shape among the kelvin-foam, the octet-truss, the body-centered cubic lattice, the simple cubic triply minimal surface (SC-TPMS), the cubic cellular core (CCC) and the honeycomb, and the composite structure may include at least two or more unit cells having different diameters.

In the present invention, the mechanical meta-material electromagnetic wave absorber can be manufactured by a single process using 3D printing.

The absorber according to the present invention can simultaneously have lightweight, high rigidity and broadband electromagnetic wave absorption characteristics, and can be produced in a required design through 3D printing and can be easily implemented in a complex overall shape, compared to a conventional electromagnetic wave absorber such as a stealth structure which requires a multi-step process.

### BRIEF DESCRIPTION OF THE DRAWINGS

FIG. 1A, FIG. 1B and FIG. 1C are diagrams for explaining electromagnetic wave absorption and a lightweight and high rigidity structure.

FIG. 2A, FIG. 2B, FIG. 2C, FIG. 2D, FIG. 2E and FIG. 2F are diagrams for explaining design variables for changes in electromagnetic wave absorption performance according to changes in the characteristics of a structure.

FIG. 3 is an experimental diagram for explaining electromagnetic wave absorption.

FIG. 4A and FIG. 4B show comparisons of relative compressive stiffness and relative compressive strength according to relative density.

FIG. 5A and FIG. 5B show a comparison of a basic structure and an absorption rate of the present invention.

### DETAILED DESCRIPTION OF THE INVENTION

Specific examples of the present invention are as follows.

Although a mechanical meta-material with characteristics of lightweight and high rigidity is difficult to implement due to the complexity of the material, it is being actively studied again by 3D printing technique in recent years.

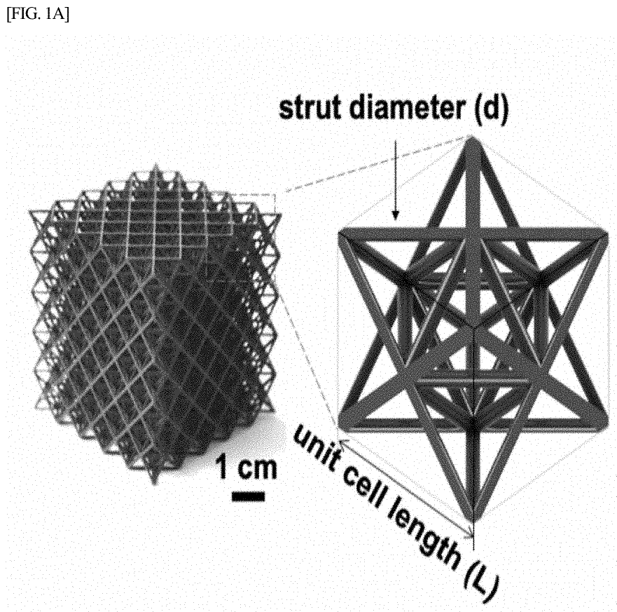

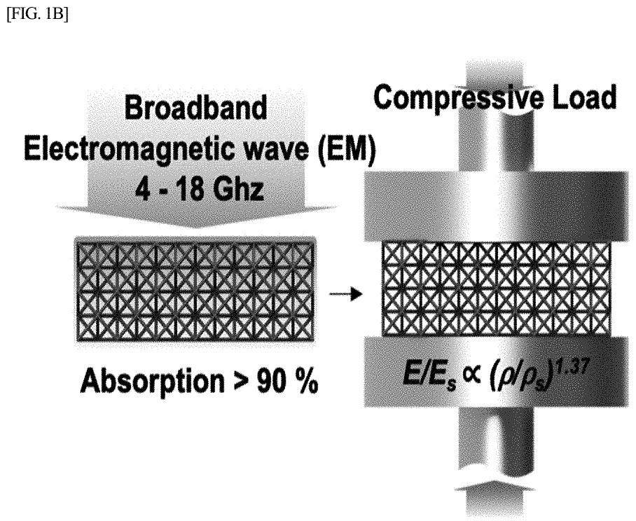

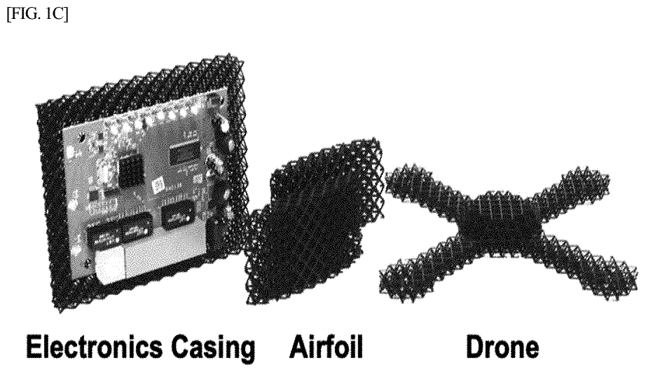

FIG. 1A is a diagram of a structure composed of a set of a unit cell and a unit cell for an octet truss, which is one of the types of mechanical meta-material with the characteristics of lightweight and high rigidity. In FIG. 1A, a diameter of a rod constituting a unit cell is referred to as a strut diameter, and a length (L) of a unit cell is a distance between points where rods supporting the unit cell meet.

When the structure of the present invention is manufactured using a dielectric loss material-based 3D printing, a multifunctional structure having a broadband electromagnetic wave absorption capacity of 4 to 18 GHz and lightweight and high rigidity characteristics is implemented as shown in FIG. 1B, and the absorption rate is greater than 90%. A test was performed to measure the relative compressive strength or relative compressive stiffness according to the relative density by applying a vertical compressive force to the structure. In addition to the vertical compression force, a test for left and right compression forces (not shown) may be performed.

In an embodiment of the present invention, a composite material containing a certain amount of carbon black in a polymer (PLA) was used, but any one or more of a polymer (resin)-carbon nanotube, a polymer (resin)-carbon fiber, a polymer (resin)-graphene, a polymer (resin)-conductive polymer can be used. Although fused filament fabrication (FFF) was used in the embodiment, a photocuring-based 3D printing process can also be utilized. The manufactured structure may be used in an electronic device case as shown in FIG. 1C to solve an electromagnetic interference (EMI) problem, or may be used as a structural material in an aircraft requiring stealth performance.

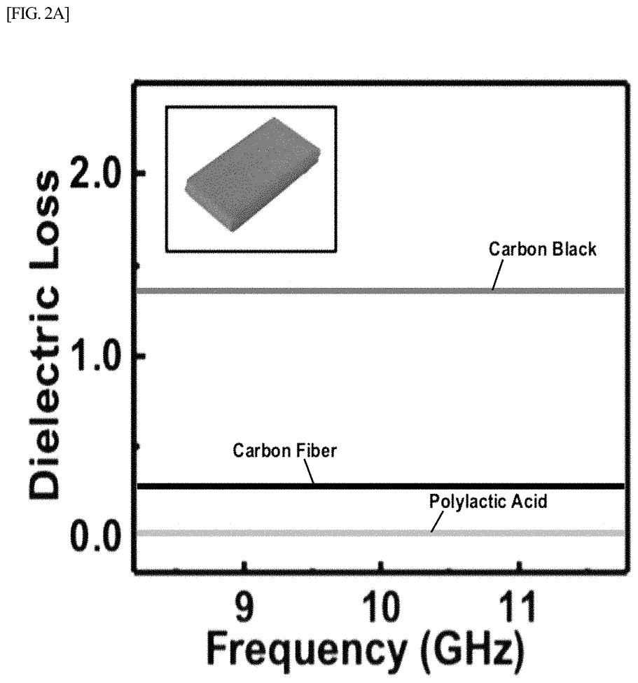

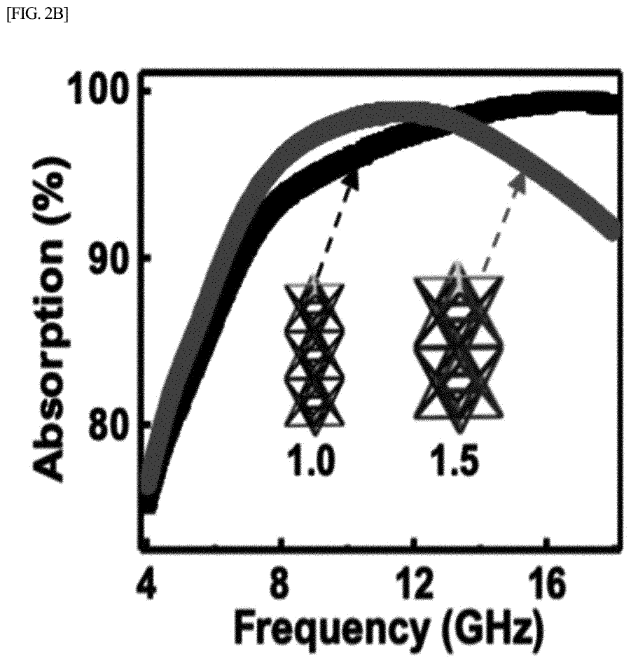

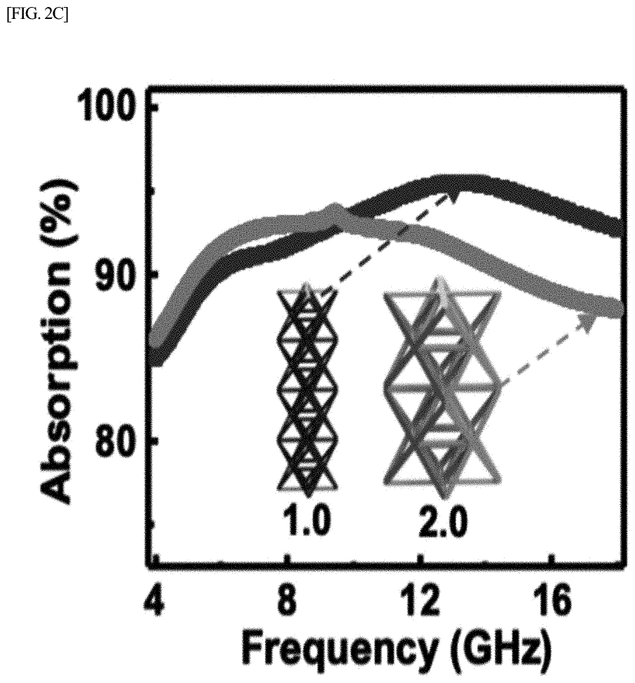

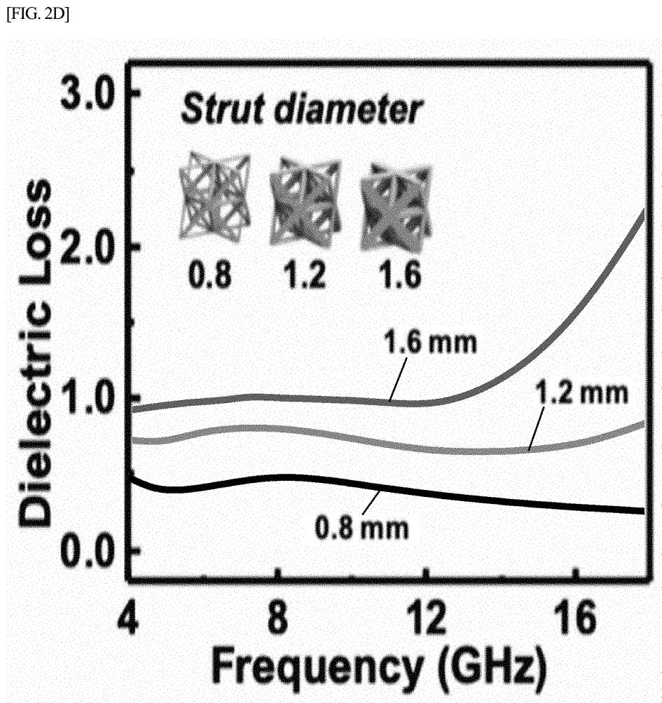

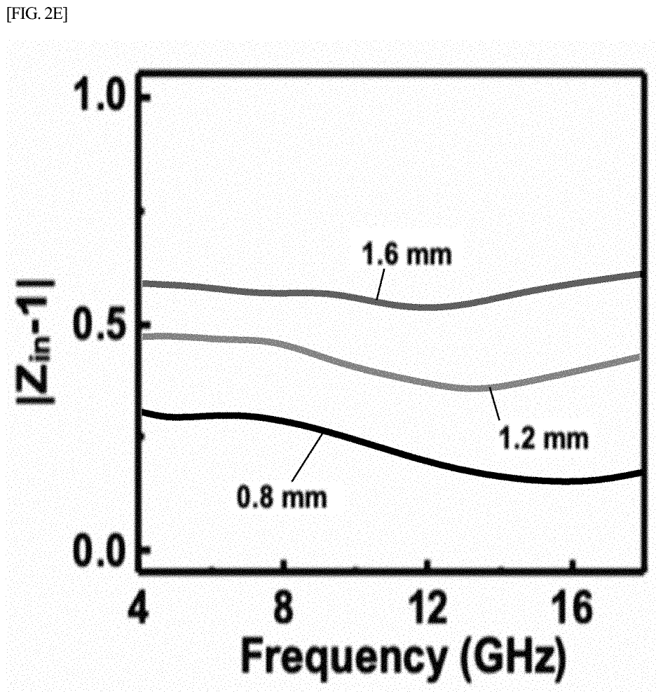

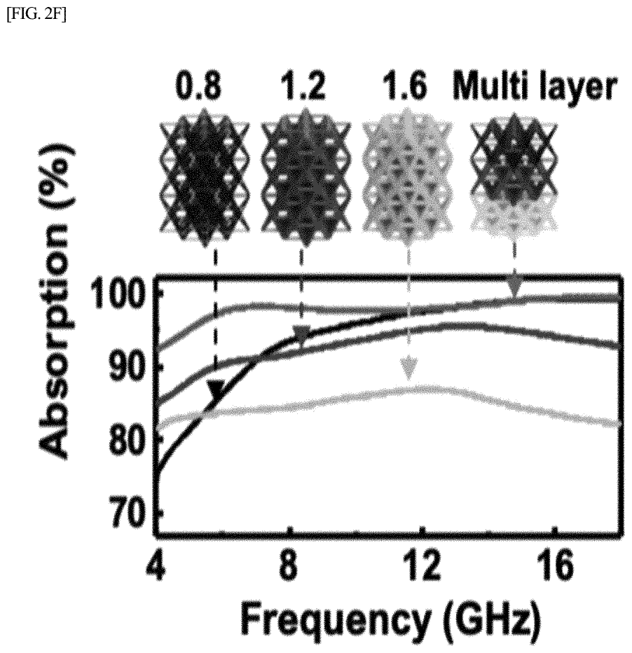

FIG. 2A is a diagram showing dielectric loss according to frequency among structure design variables according to the material of the structure. It will be described based on the octet truss, which is one of the mechanical meta-materials. The definition of absorption is follows: Linear Absorption=1−Transmission−Reflection.

In other words, it is necessary to minimize reflection, and to attenuate transmission of the energy of electromagnetic waves that have penetrated into the structure with the dielectric loss characteristics of the material.

Therefore, by analyzing the electromagnetic properties of various materials, a dielectric loss material to be used for 3D printing is selected, and in this embodiment, a material for the FFF process containing 20% by weight of carbon black in the polymer (PLA) is selected.

FIG. 2 shows the change in electromagnetic wave absorption performance according to the change of the structure by controlling the dielectric properties of the structure. As the change in the effective permittivity value, the absorption rate for each wavelength band can be controlled through the impedance change. In addition, it is possible to control the effective permittivity by changing the length, thickness, and relative density of the unit cell with the structural parameter value of the unit cell. The thickness of the unit cell refers to a strut diameter.

FIG. 2A shows the dielectric loss characteristic when a carbon-based material is mixed compared to that when plastic is mixed. In the target radar wavelength band, it can be seen that the dielectric loss is larger when carbon fiber is applied than when polylactic acid is applied, and the dielectric loss is larger when carbon black is applied than when carbon fiber is applied.

FIGS. 2B and 2C show the comparison of the sizes of unit structures.

In FIG. 2B, when the size of the unit structure increases from 1.0 to 1.5, it is rather reversed in a radar wavelength band larger than 12 GHz and the absorption rate is lowered. On the contrary, when the size of the unit structure is 1.0, the absorption rate shows a steady increase.

FIG. 2C shows that when the size of the unit structure increases from 1.0 to 2.0, the reversal point of the absorption rate is between 8 and 12 GHz. It shows that the point when the size of the unit structure is 2.0 becomes smaller than the point when the size of the unit structure is 1.0.

The size of the unit structure is the difference in volume based on the size of the unit structure of 1.0, and has no unit, but the absolute size (length) of the unit structure of 1.0 is about 10 mm. If the absolute size of the unit structure is 2.0, the horizontal and vertical lengths each increase by about two times based on the unit cell shown in FIG. 2C.

FIGS. 2B and 2C show analysis results of electromagnetic wave absorptivity according to the size of the unit structure. Although it was confirmed that the octet truss designed with the selected dielectric loss material basically showed the electromagnetic wave absorption ability, the smaller the unit structure size, the higher the electromagnetic wave absorptivity on the high-frequency side, even though it is a unit structure with the same volume ratio (air-material).

However, the smaller the size of the unit structure, the longer the manufacturing time is generated, and it is necessary to pay attention to this point. In this embodiment, it was confirmed that the absorption rate was the same when the size of the unit structure was 10 mm or less, but the absorption rate in the high-frequency region changed from the size of the unit structure of 10 mm or more. The absorption rate of the structure size (1.0 in the figure) of width-length-height of 10 mm is more preferable.

FIGS. 2D and 2E show the results of analysis of effective EM properties according to the volume ratio (air-material) of the unit structure. The volume ratio (air-material) of the unit structure was controlled through the change in the strut diameter of the rod constituting the unit structure. In reality, air is a gas that fills the space except for the material in the unit structure, meaning that it is a normal atmosphere.

FIG. 2D shows the dielectric loss according to the size of the strut diameter of the unit cell. The larger the strut diameter, the greater the dielectric loss, and the larger the radar wavelength, the more pronounced the difference.

The strut diameter refers to the thickness of the rod constituting the unit cell.

In particular, when the strut diameter is 1.6 mm, it indicates that the dielectric loss increases rapidly from the radar wavelength band of 12 to 16 GHz section.

As the volume ratio of the dielectric loss material increases with an increase in the strut diameter, the dielectric loss value responsible for electromagnetic wave energy attenuation increases, but at the same time, as shown in FIG. 2(E), there is a difference between the effective impedance (Zᵢₙ) of the unit structure and an impedance of free space (Zᵢₙ normalized value=1).

FIG. 2E shows an impedance according to the size of the strut diameter of the unit cell, and as the strut diameter increases over the entire radar wavelength band, the volume ratio (air-material) of the unit structure is controlled by the strut diameter of the rod constituting the unit structure.

That is, it is explained that the greater the difference between the volume ratio (air-material) of the unit structure and the impedance of free space, the greater the surface reflection occurs when the electromagnetic wave is incident on the structure, making it difficult to implement high absorption capacity. The impedance of free space refers to the impedance of free space in which there is no material constituting the unit structure, and is a standard for explaining the impedance difference according to the volume ratio of the unit structure to the impedance of free space.

Conversely, as the volume ratio is low and similar to the impedance of free space, the electromagnetic wave penetrates well into the structure, but the dielectric loss value is low, so that the electromagnetic wave attenuation does not occur well. FIG. 2(F) shows this state well.

In FIG. 2F, although a model with the strut diameter of 1.6 mm, the largest volume ratio, has the largest dielectric loss value compared to the models with the strut diameters of 0.8 mm and 1.2 mm, the absorption rate is rather poor by surface reflection according to the strut diameter.

Among the models with the strut diameters of 0.8, 1.2 and 1.6 mm, the model with the strut diameter of 1.2 mm, which has an impedance similar to the impedance of free space while having some dielectric loss values, showed an overall even absorption according to the radar wavelength band.

That is, by sequentially stacking the models with the strut diameters of 0.8, 1.2, 1.6 mm and combining the advantages of each model (0.8 mm: incident electromagnetic wave penetration, 1.6 mm: electromagnetic wave energy attenuation), the absorber with more than 90% absorption across 4 to 18 GHz can be additionally implemented. That is, it is a multilayer unit structure in which a first layer with the strut diameter of 0.8 mm, a second layer with the strut diameter of 1.2 mm, and a third layer with the strut diameter of 1.6 mm are sequentially stacked.

In FIG. 2F, as the size of the unit structure increases with the strut diameters of 0.8, 1.2, and 1.6 mm, a section with a relatively small dielectric loss in most areas of the radar wavelength band is further increased, and the reversal point of dielectric loss is also located in a lower radar wavelength band. On the other hand, in the case of the multilayer unit structure, the overall dielectric loss is higher than the dielectric losses of the unit structures with the strut diameters of 0.8, 1.2, and 1.6 nm.

As in FIG. 2F, different absorption rates may be exhibited even in the same shape and density of the structure through the implementation of physical properties for each layer. The multilayer is a structure in which a strut diameter is different for each layer in a specific unit structure, and refers to a composite structure constituting a multilayer.

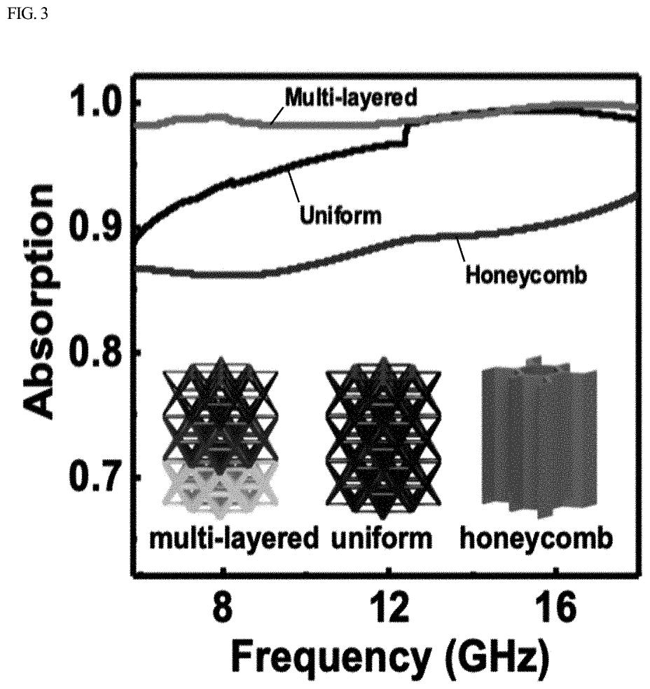

FIG. 3 shows that an absorption rate is greater in an octet truss than in a honeycomb, and the absorption rate is greater in a multilayer octet truss than in a single octet truss.

As in FIG. 3, the honeycomb also has an electromagnetic wave absorptivity when electromagnetic waves are incident in the direction in which the pores are drilled, but when electromagnetic waves are incident in the direction of the partition walls, the electromagnetic wave absorptivity does not appear, so unlike the octet truss, electromagnetic waves bounce (reflective) in the incident direction is shown.

It shows that it is possible to change the absorption rate according to the difference in unit structural shapes, such as an octet-truss, a honeycomb, and the like even in the same material and density.

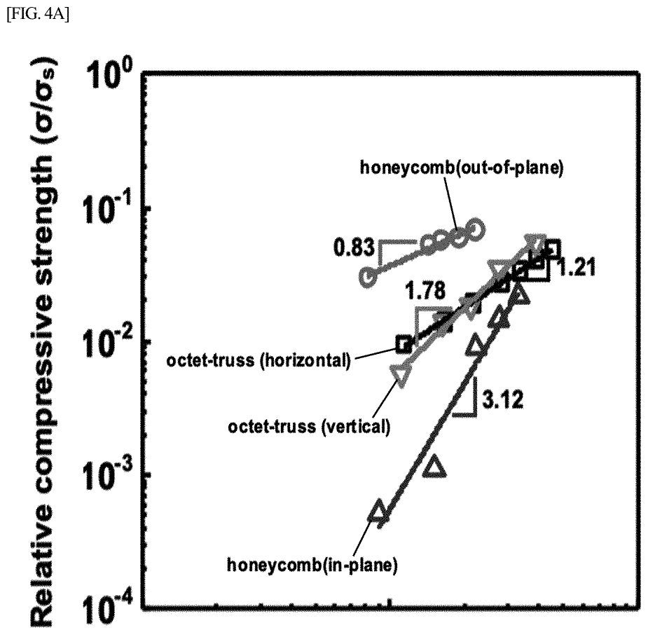

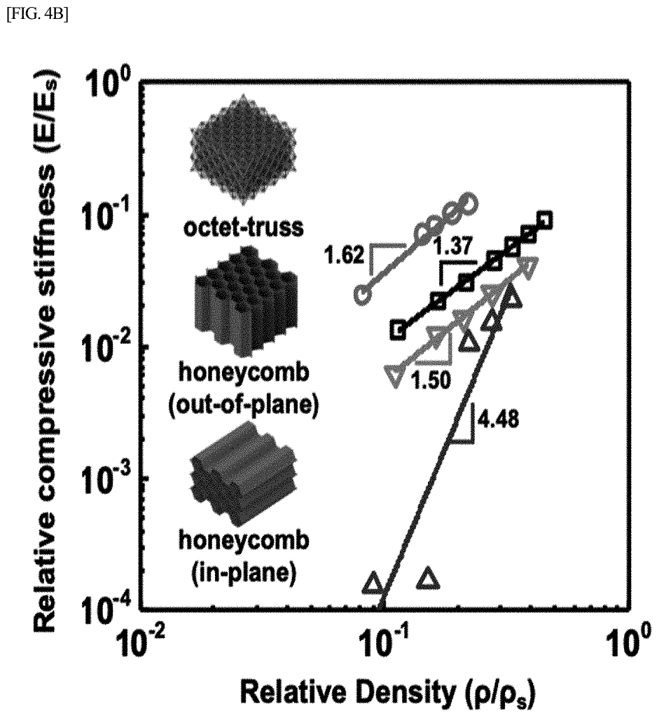

FIGS. 4 (A) and (B) show the comparison of a mechanical meta-material octet-truss (octet-truss) and the honeycomb, wherein the X-axis is the relative density, the Y-axis is relative compressive strength and relative compressive stiffness. This is the comparison of the characteristics of maintaining relative compressive stiffness to relative density. That is, FIG. 4(A) shows the comparison between horizontal and vertical structures for the octet-truss and between out-of-plane and in-plane structures for the honeycomb.

In the horizontal structure of the octet-truss, when a compressive force is applied to the left and right, the relative compressive strength and the relative compressive stiffness of the Y-axis with respect to the relative density of the X-axis are 1.21 and 1.37, respectively.

In the vertical structure of the octet-truss, when a compressive force is applied up and down, the inclinations of the relative compressive strength and the relative compressive stiffness of the Y-axis with respect to the relative density of the X-axis are 1.78 and 1.5, respectively.

The planar structure of the honeycomb refers to a side portion, not a pore portion, as shown in FIG. 4(B), and the out-of-plane structure is the pore portion as shown in FIG. 4(B).

The subscript s corresponding to the denominator in the relative compressive strength to the relative density and the relative compressive stiffness to the relative density refers to a full density with respect to a volume constituting the unit structure.

That is, the expression ‘relative’ refers to a relative value for the full density with respect to the volume constituting the unit structure.

In the relative compressive strength with respect to the relative density, the out-of-plane structure of the honeycomb is excellent and the in-plane structure of the honeycomb is poor, and the vertical or horizontal structure of the octet truss has similar property.

In the relative compressive stiffness with respect to the relative density, the out-of-plane structure of the honeycomb is excellent, the in-plane structure of the honeycomb is poor, and the horizontal structure of the octet truss is better that the horizontal structure of the octet truss.

As a whole, the relative compressive strength and relative compressive stiffness of the unit structure decrease exponentially when the relative density decreases.

The out-of-plane structure of the honeycomb refers to a structure in which the inclinations of the relative compressive strength and the relative compressive stiffness of the Y-axis with respect to the relative density of the X-axis are 0.83 and 1.62, respectively, when the inlet and outlet of the honeycomb are positioned in the vertical direction and a compressive force is applied up and down.

The in-plane structure of the honeycomb refers to a structure in which the inclinations of the relative compressive strength and the relative compressive stiffness of the Y-axis with respect to the relative density of the X-axis are 3.12 and 4.48, respectively, when the inlet and outlet of the honeycomb are positioned in the lateral direction and a compressive force is applied up and down.

Compared with the honeycomb, the octet-truss in FIG. 4(A) has the relative strength reduction ratio maintained at 1.21 to 1.78 depending on the output direction when the relative density decreases.

On the other hand, the honeycomb has a wider range of the relative strength reduction ratio of 0.83 to 4.48 depending on the output direction when the relative density decreases.

In general, in the octet-truss, the relative compressive strength and relative compressive stiffness are small compared to the relative density, so it is more stable. However, the most stable structure among them is the out-of-plane structure of the honeycomb.

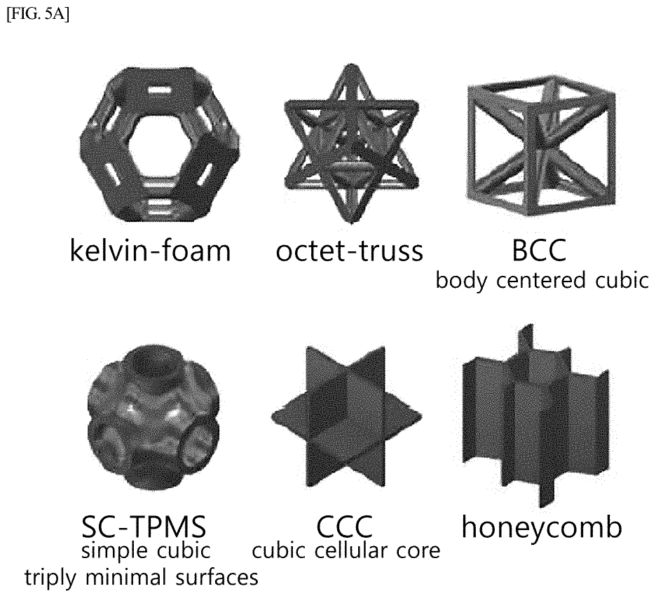

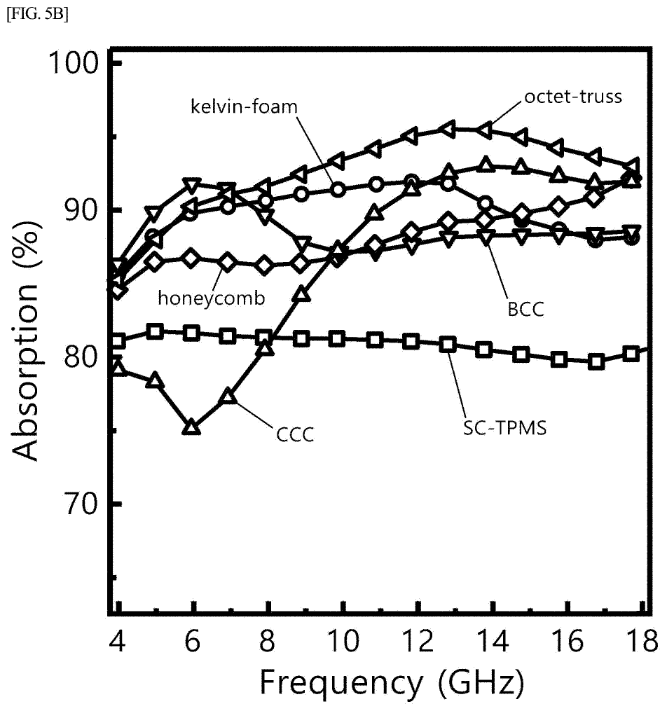

As shown in FIGS. 5A and 5B, the present invention can be used as an interior material of aircraft and drones that can be utilized as a stealth structure, an interior material having an electromagnetic wave absorption function to prevent malfunction of electronic products, and an interior material to prevent the malfunction caused by electromagnetic wave reception and diffuse reflection of autonomous vehicles, and the present invention can apply a kelvin-foam, an octet-truss, a body centered cubic lattice, a SC-TPMS (simple cubic triply minimal surface), a CCC (cubic cellular core) and a honeycomb.

In FIG. 5B, it can be seen that the overall absorption rate of the octet-truss is the best, the absorption rate of the BCC is good at 6 to 8 GHz or less, and the SC-TPMS has the lowest absorption rate as a whole.

What is claimed is:

1. A mechanical meta-material based electromagnetic wave absorber, wherein a shape of the electromagnetic wave absorber is any one of a kelvin-foam, an octet-truss, a body-centered cubic lattice, a simple cubic triply minimal surface (SC-TPMS), and a cubic cellular core (CCC) and a honeycomb,
a dielectric loss of the electromagnetic wave absorber is controlled by changing a strut diameter of a unit cell including at least one of carbon black, carbon nanotube, carbon fiber and graphene constituting the electromagnetic wave absorber.

2. The mechanical meta-material based electromagnetic wave absorber according to claim 1, wherein the unit cell of the electromagnetic wave absorber includes a multilayer composite structure manufactured by combining the unit cells having different diameters.

3. The mechanical meta-material based electromagnetic wave absorber according to claim 2, wherein the composite structure includes a combination of a plurality of structures having the same shape among the kelvin-foam, the octet-truss, the body-centered cubic lattice, the simple cubic triply minimal surface (SC-TPMS), the cubic cellular core (CCC) and the honeycomb.

4. The mechanical meta-material based electromagnetic wave absorber according to claim 3, wherein the composite structure includes at least two or more unit cells having different diameters.
